(19) United States
(12) Patent Application Publication
(10) Pub. No.: US 2025/0301022 A1
(43) Pub. Date: Sep. 25, 2025

(54) DATA TRANSMISSION METHOD AND SYSTEM, ELECTRONIC DEVICE, AND NONVOLATILE READABLE STORAGE MEDIUM

(71) Applicant: SUZHOU METABRAIN INTELLIGENT TECHNOLOGY CO., LTD., Suzhou (CN)

(72) Inventors: Xinglong WANG, Suzhou (CN); Yanming SU, Suzhou (CN); Baoyang LIU, Suzhou (CN); Huatang BAN, Suzhou (CN); An WU, Suzhou (CN); Jinfeng LI, Suzhou (CN)

(21) Appl. No.: 19/228,091

(22) Filed: Jun. 4, 2025

Related U.S. Application Data
(63) Continuation of application No. PCT/CN2024/109626, filed on Aug. 2, 2024.

(30) Foreign Application Priority Data
Aug. 2, 2023 (CN) 202310962741.7

(51) Int. Cl. H04L 9/40

(52) U.S. Cl. CPC H04L 63/205; H04L 63/0236; H04L 63/166

(57) ABSTRACT

A data transmission method and system, an electronic device, and a non-transitory readable storage medium are provided by the present application. In order to solve the problem that data transmitted by using the non-security protocol is easily stolen, the data transmission method includes: parsing request information in a first user request in response to acquiring the first user request initiated based on any one of non-security protocols; determining a target security protocol; and forming the request information into a second user request according to a constraint format corresponding to the target security protocol, and transmitting the second user request to a server, enabling the server to respond to the second user request and return corresponding data to the client.

### CROSS-REFERENCE TO RELATED APPLICATION

This application claims the priority of the Chinese Patent application filed on Aug. 2, 2023 before the China National Intellectual Property Administration with the application number of 202310962741.7, and the title of “DATA TRANSMISSION METHOD AND SYSTEM, ELECTRONIC DEVICE, AND READABLE STORAGE MEDIUM”, which is incorporated herein in its entirety by reference.

### FIELD

The present application relates to the field of data transmission and, more particularly, to a data transmission method and system, an electronic device, and a non-transitory readable storage medium.

### BACKGROUND

During the development of monitoring and management technologies, due to differences in user management methods, different user management clients employ different interaction protocols to perform data interaction with monitoring and management systems in servers. Currently, the interaction protocols commonly used by the users include: intelligent platform management interface (IPMI), simple network management protocol (SNMP), electronic mail (Email), hypertext transfer protocol (HTTP), hypertext transfer protocol secure (HTTPS), and certain proprietary protocols, wherein transmission encryption algorithms of the interaction protocols such as IPMI, SNMP, and Email are outdated, making data easy to be stolen during transmission, and the data transmission security is relatively poor.

### SUMMARY

An object of the present application is to provide a data transmission method and system, an electronic device, and a non-transitory readable storage medium, which may support conversion of multiple non-security protocols, and make a user request based on a target security protocol insusceptible to be stolen during transmission, thereby the security and the reliability of data transmission are improved.

In order to solve the above technical problems, a data transmission method is provided by the present application, which is applied to a client. The data transmission method includes:
parsing request information in a first user request in response to acquiring the first user request initiated based on any one of non-security protocols;
determining a target security protocol; and
forming the request information into a second user request according to a constraint format corresponding to the target security protocol, and transmitting the second user request to a server, enabling the server to respond to the second user request and return corresponding data to the client.

In an exemplary embodiment, the process of forming the request information into the second user request according to the constraint format corresponding to the target security protocol includes:
determining the constraint format corresponding to the target security protocol; and
adding the request information into a field corresponding to the target security protocol according to the constraint format to obtain the second user request.

In an exemplary embodiment, the request information includes a protocol type;
the process of transmitting the second user request to the server includes:
transmitting the second user request to a second secure port, corresponding to the protocol type, of the server through a first secure port corresponding to the protocol type; and
the process of enabling the server to respond to the second user request and return the corresponding data to the client includes:
after the server receives the second user request through the second secure port, forwarding the second user request to a non-secure port corresponding to the second secure port for processing, and returning the corresponding data to the client.

In an exemplary embodiment, before the acquiring the first user request initiated based on any one of the non-security protocols, the data transmission method further includes:
determining a transmission port corresponding to each non-security protocol; and
monitoring each transmission port to intercept the first user request outputted through the transmission port.

In an exemplary embodiment, the data transmission method further includes:
transmitting the first user request to the server, in response to acquiring the first user request initiated based on any one of the non-security protocols, enabling the server to respond to the first user request and return the corresponding data to the client.

In an exemplary embodiment, the data transmission method further includes:
determining a current interaction mode, wherein the current interaction mode includes a secure mode and a non-secure mode;
the process of transmitting the first user request to the server, in response to acquiring the first user request initiated based on any one of the non-security protocols includes:
determining that the current interaction mode is the non-secure interaction mode, transmitting the first user request to the server in response to acquiring the first user request initiated based on any one of the non-security protocols; and
the data transmission method further includes:
determining that the current interaction mode is the secure interaction mode, rejecting transmitting the first user request to the server, in response to acquiring the first user request initiated based on any one of the non-security protocols.

In an exemplary embodiment, the data transmission method further includes:
prompting first information and second information, wherein the first information corresponds to the secure mode, and the second information corresponds to the non-secure mode; and
the process of determining the current interaction mode includes:
determining that the current interaction mode is the secure mode, in response to receiving a first selection instruction transmitted by a user based on the first information, and
determining that the current interaction mode is the non-secure mode, in response to receiving a second selection instruction transmitted by the user based on the second information.

In an exemplary embodiment, the data transmission method further includes:
determining a current interaction mode, wherein the current interaction mode includes a secure mode and a non-secure mode;
the process of enabling the server to respond to the first user request and return the corresponding data to the client includes:
in response to the current interaction mode being the non-secure interaction mode, enabling the server to respond to the first user request and return the corresponding data to the client; and
the data transmission method further includes:
in response to the current interaction mode being the secure interaction mode, enabling the server not to respond to the first user request.

In an exemplary embodiment, the data transmission method further includes:
prompting first information and second information, wherein the first information corresponds to the secure mode, and the second information corresponds to the non-secure mode; and
the process of determining the current interaction mode includes:
determining that the current interaction mode is the secure mode, in response to receiving a first selection instruction transmitted by a user based on the first information, and
determining that the current interaction mode is the non-secure mode, in response to receiving a second selection instruction transmitted by the user based on the second information.

In an exemplary embodiment, the process of enabling the server not to respond to the first user request, in response to the current interaction mode being the secure interaction mode includes:
in response to the current interaction mode being the secure interaction mode, determining, by the server, all target ports configured to receive the first user request, and responding, by the server, to none of the first user request received by any one of the target ports.

In an exemplary embodiment, the process of determining the target security protocol includes:
determining the target security protocol based on a user selection instruction.

In an exemplary embodiment, the process of determining the target security protocol includes:
acquiring a non-security protocol corresponding to the first user request; and determining the target security protocol corresponding to the non-security protocol.

In an exemplary embodiment, the data transmission method further includes:
establishing a conversion relationship between each non-security protocol and each security protocol according to a user setting instruction; and
the process of determining the target security protocol includes:
determining the target security protocol according to the non-security protocol corresponding to the first user request and the conversion relationship.

In an exemplary embodiment, the request information includes an Internet protocol (IP) address of a target server; and
the process of transmitting the second user request to the server includes:
transmitting the second user request to the target server according to the IP address.

In an exemplary embodiment, the non-security protocol includes one or more of an intelligent platform management interface protocol, a simple network management protocol, and an electronic mail protocol.

In an exemplary embodiment, the request information includes a protocol type and a protocol data packet;
the process of enabling the server to respond to the second user request and return the corresponding data to the client includes:
parsing, by the server, the protocol type and the protocol data packet in the second user request to obtain data corresponding to the protocol type and the protocol data packet; and
forming the data into a return data packet according to the constraint format corresponding to the target security protocol, and transmitting the return data packet to the client.

In an exemplary embodiment, the data transmission method further includes:
parsing the return data packet, and forming the data in the return data packet into a non-security protocol data packet according to the constraint format of the target security protocol.

In an exemplary embodiment, the process of parsing the return data packet includes:
parsing a protocol type in the return data packet; and
the data transmission method further includes:
determining the target security protocol according to the protocol type in the return data packet.

In order to solve the above technical problems, a data transmission system is further provided by the present application, the data transmission system includes:
a monitoring module, configured to parse request information in a first user request in response to acquiring the first user request initiated based on any one of the non-security protocols;
a determination module, configured to determine a target security protocol; and
an aggregation processing module, configured to form the request information into a second user request according to a constraint format corresponding to the target security protocol, and transmit the second user request to a server, enabling the server to respond to the second user request and return corresponding data to a client.

In order to solve the above technical problems, an electronic device is further provided by the present application, which includes:
a memory, configured to store computer programs; and
a processor, configured to implement the steps of the data transmission method according to any one of embodiments stated above in response to executing the computer programs.

In order to solve the above technical problems, a data interaction system is further provided by the present application, which includes a server and a client, wherein the client includes the electronic device as stated above.

In order to solve the above technical problems, a non-transitory readable storage medium is further provided by the present application, which has computer programs stored thereon, wherein the computer programs, in response to being executed by a processor, implement the steps of the data transmission method according to any one of embodiments stated above.

A data transmission method is provided by the present application. After the first user request initiated by a user through any one of the non-security protocols is acquired, the request information in the first user request is regrouped into the second user request according to the constraint format of the determined target security protocol, and then the second user request is transmitted from the client, the conversion of a plurality of non-security protocols is supported, and the second user request based on the target security protocol is less susceptible to be stolen during the transmission, thereby the security and the reliability of the data transmission are improved. A data transmission system, an electronic device, a data interaction system, and a non-transitory readable storage medium are further provided by the present application, which have the same beneficial effects as the aforementioned data transmission method.

### BRIEF DESCRIPTION OF THE DRAWINGS

In order to describe the embodiments of the present application more clearly, the drawings required to be used in the embodiments are introduced briefly below. Apparently, the drawings in the following description show only some embodiments of the present application, and those ordinary skilled in the art may still obtain other drawings according to these drawings without paying any creative efforts.

FIG. 1 is a flowchart of steps of a data transmission method according to the present application;

FIG. 2 is a schematic diagram of data transmission between a server and a client according to the present application;

FIG. 3 is a schematic structural diagram of a data transmission system according to the present application;

FIG. 4 is another schematic diagram of data transmission between a server and a client according to the present application;

FIG. 5 is another schematic diagram of data transmission between a server and a client according to the present application;

FIG. 6 is yet another schematic diagram of data transmission between a server and a client according to the present application; and

FIG. 7 is another schematic diagram of data transmission between a server and a client according to the present application.

### DETAILED DESCRIPTION

A core of the present application is to provide a data transmission method and system, an electronic device, and a non-transitory readable storage medium, which may support conversion of multiple non-security protocols, and make a user request based on a target security protocol insusceptible to be stolen during transmission, thereby the security and the reliability of the data transmission are improved.

In order to make the object, technical solutions and advantages of embodiments of the present application clearer, the technical solutions in the embodiments of the present application are described clearly and completely in conjunction with drawings in the embodiments of the present application. Apparently, the described embodiments are some embodiments of the present application, not all embodiments. All other embodiments obtained by a person skilled in the art based on the embodiments of the present application without paying any creative efforts shall fall within the protection scope of the present application.

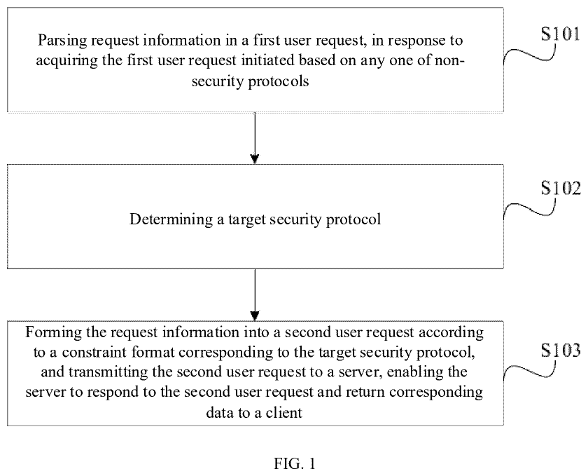

In a first aspect, referring to FIG. 1, FIG. 1 is a flowchart of steps of a data transmission method according to the present application. The data transmission method includes:
S101, parsing request information in a first user request, in response to acquiring the first user request initiated based on any one of the non-security protocols.

It may be understood that the interaction between a user management client and a server management system is based on a client-server (CS) architecture, that is, a user initiates the user request through the client, and the server responds to the user request transmitted from the client. The client may support the user requests initiated based on multiple protocols, the user requests may include the user request initiated based on the non-security protocol, i.e., the first user request, and may also include the user request initiated based on the security protocol.

In the present embodiment, the security protocol is an interaction protocol with advanced encryption algorithms and high security, such as a secure socket layer (SSL) protocol, a transport layer security (TLS) protocol, and an HTTPS protocol; and the non-security protocol is an interaction protocol with outdated encryption algorithms and low security, such as an IPMI protocol, an SNMP protocol, or an Email protocol. Considering that the encryption algorithms employed by the security protocols are advanced and high in security, the user request initiated based on the security protocol is less susceptible to be stolen during transmission, the client may directly transmit the user request initiated based on the security protocol to the server for processing. Correspondingly, since the user request initiated based on the non-security protocol is poor in transmission security and highly susceptible to be stolen when being directly transmitted to the server, in the present embodiment, the first user request initiated by the client based on the non-security protocol is monitored, and after the first user request initiated based on any one of the non-security protocols is acquired, the first user request is processed and then outputted, thereby the transmission security of the user request outputted from the client is improved.

In response to acquiring the first user request initiated by the user based on any one of the non-security protocols, the first user request is first parsed to obtain the request information corresponding to a plurality of fields of the non-security protocol, the request information includes, but is not limited to, an Internet protocol (IP) address of a target server, a protocol type of a currently-employed non-security protocol, and a protocol data packet. S102, determining a target security protocol.

In some embodiments, the process of determining the target security protocol includes:
determining the target security protocol based on a user selection instruction.

In some embodiments, the process of determining the target security protocol includes:
acquiring a non-security protocol corresponding to the first user request; and
determining the target security protocol corresponding to the non-security protocol.

S103, forming the request information into a second user request according to a constraint format corresponding to the target security protocol, and transmitting the second user request to a server, enabling the server to respond to the second user request and return corresponding data to the client,

Wherein the constraint format belongs to a common sense to a person skilled in the art. The target security protocols may be of a same type or multiple types; when one type of target security protocols is used, all non-security protocols are converted according to the same target security protocol; and when multiple types of target security protocols are used, a corresponding relationship between the target security protocols and the non-security protocols may be one-to-one, one-to-more, more-to-one, or more-to-more. For example, assuming that the non-security protocols include the following four types: A1, A2, A3 and A4, the target security protocol may be set as B1, that is, whether the first user request is initiated based on A1, A2, A3 or A4, the second user request is converted according to the constraint format of B1 to obtain the second user request; and assuming that the target security protocols include B1, B2, B3, and B4, in a case that the first user request is initiated based on A1, the first user request is converted according to the constraint format of B1 to obtain the second user request; in a case that the first user request is initiated based on A2, the first user request is converted according to the constraint format of B2 to obtain the second user request, and the rest is done in the same manner; and moreover, the first user request may also be converted according to the following solutions, that is, in a case that the first user request is initiated based on A1 or A2, the first user request is converted according to the constraint format of B1 to obtain the second user request; and in a case that the first user request is initiated based on A3 or A4, the first user request is converted according to the constraint format of B3 to obtain the second user request.

Of course, the above conversion solutions are merely illustrative examples. The target security protocol may be selected according to actual engineering requirements, provided that the client and the server maintain consistent agreements. The present embodiment does not limit this.

In some embodiments, the process of forming the request information into the second user request according to the constraint format corresponding to the target security protocol includes:
determining the constraint format corresponding to the target security protocol; and
adding the request information into a field corresponding to the target security protocol according to the constraint format to obtain the second user request.

In the previous step, the information of each field of the non-security protocol, i.e., the request information is acquired, the IP address of the target server, the protocol type of the currently-employed non-security protocol, and the protocol data packet are regrouped according to the constraint format of the target security protocol, and the corresponding request information is added into the fields corresponding to the target security protocol to obtain the second user request.

Assuming that the target security protocol is the HTTPS protocol, the request information such as the IP address of the target server, the protocol type of the currently-employed non-security protocol, and the protocol data packet is regrouped according to the constraint format of the HTTPS protocol, and the regrouped second user request is shown as “a protocol type field: IPMI, and protocol data fields: parameter a, parameter b, and parameter c”. The second user request is transmitted to the target server according to the IP address parsed above, so that the target server responds to the second user request and returns corresponding data to the client.

As may be seen in the present embodiment, after the first user request initiated by the user through any one of the non-security protocols is acquired, the request information in the first user request is regrouped according to the constraint format of the determined target security protocol to obtain the second user request, and then the second user request is transmitted from the client, the conversion of multiple non-security protocols is supported, and the second user request based on the target security protocol is less susceptible to be stolen during the transmission, thereby the security and the reliability of data transmission are improved.

On the basis of the above embodiments:
in some embodiments, the request information includes a protocol type;
the process of transmitting the second user request to the server includes:
transmitting the second user request to a second secure port, corresponding to the protocol type, of the server through a first secure port corresponding to the protocol type; and

the process of enabling the server to respond to the second user request and return the corresponding data to the client includes:
after the server receives the second user request through the second secure port, forwarding the second user request to a non-secure port corresponding to the second secure port for processing, and returning the corresponding data to the client.

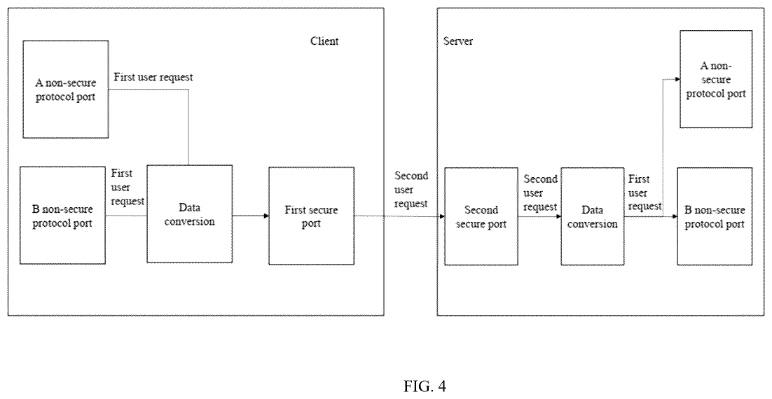

It may be seen from FIG. 4 that the client in the present application includes a first secure port corresponding to each security protocol, each first secure port is configured to transmit the second user request generated based on the corresponding security protocol, after the target security protocol is determined, the first secure port corresponding to the target security protocol is determined, and the second user request is transmitted through the first secure port; and the server also includes a non-secure port corresponding to each non-security protocol, the second secure port corresponds to the non-secure port, after the server receives the second user request, the second user request is transmitted to the corresponding non-secure port for subsequent processing within the server based on the second secure port receiving the second user request and the corresponding relationship, after obtaining the corresponding data, and the data is returned to the client through the non-secure port transmitting the second user request, the second secure port, and the first secure port.

In some embodiments, before the acquiring the first user request initiated based on any one of the non-security protocols, the data transmission method further includes:
determining a transmission port corresponding to each non-security protocol; and
monitoring each transmission port to intercept the first user request outputted through the transmission port.

Considering that the client supports the data interaction between multiple non-security protocols and the server, in the present embodiment, the transmission port corresponding to each non-security protocol is monitored, when the user initiates the first user request based on a non-security protocol, the transmission port corresponding to the non-security protocol may output the first user request, and when the first user request outputted from any transmission port is monitored, the first user request is intercepted, and prevented from being directly transmitted to the server, so that the intercepted first user request is parsed subsequently to obtain the second user request.

In some embodiments, the data transmission method further includes:
transmitting the first user request to the server, in response to acquiring the first user request initiated based on any one of the non-security protocols, enabling the server to respond to the first user request and return the corresponding data to the client.

In the present embodiment, considering that the client supports multiple non-security protocols, the present embodiment further remains a solution of directly transmitting the first user request initiated based on the non-security protocol from the client, thereby improving the universality. In the present embodiment, the corresponding interaction solution may be selected according to a current interaction mode between the client and the server; the interaction mode includes a secure mode and a non-secure mode; in a case that the current interaction mode is the secure mode, the client and the server are controlled to interact with each other only through the second user request; and in a case that the current interaction mode is the non-secure interaction mode, the client and the server are controlled to interact with each other through the first user request or through the second user request.

In some embodiments, the data transmission method further includes:
determining a current interaction mode, wherein the current interaction mode includes a secure mode and a non-secure mode;
the process of transmitting the first user request to the server in response to acquiring the first user request initiated based on any one of the non-security protocols includes:
determining that the current interaction mode is the non-secure interaction mode, transmitting the first user request to the server, in response to acquiring the first user request initiated based on any one of the non-security protocols; and
the data transmission method further includes:
determining that the current interaction mode is the secure interaction mode, rejecting transmitting the first user request to the server, in response to acquiring the first user request initiated based on any one of the non-security protocols.

In the present embodiment, in a case that the current interaction mode is the secure interaction mode, in response to the presence of the first user request, initiated based on the non-security protocol, on the client, the first user request is intercepted, causing the client not to output the first user request directly to the server, thereby the data transmission security is improved.

In some embodiments, in response to the current interaction mode being the secure interaction mode, when the first user request initiated based on any one of the non-security protocols is acquired, while rejecting transmitting the first user request to the server, the data transmission method further includes:
generating a prompting message corresponding to re-initiating a user request.

Considering that after the first user request is intercepted, the user request cannot be responded, and the prompting message corresponding to re-initiating the user request is generated then, to facilitate the user to re-initiate a user request.

In some embodiments, the data transmission method further includes:
prompting first information and second information, wherein the first information corresponds to the secure mode, and the second information corresponds to the non-secure mode;
the process of determining the current interaction mode includes:
determining that the current interaction mode is the secure mode, in response to receiving a first selection instruction transmitted by the user based on the first information; and
determining that the current interaction mode is the non-secure mode, in response to receiving a second selection instruction transmitted by the user based on the second information.

It may be understood that the first information and the second information may be prompted on an interaction device of the client, and the user may select the current interaction mode between the client and the server according to the first information and the second information. For example, assuming that the interaction device is provided with a security switch, on and off of the security switch correspond to the first information and the second information respectively, and the user may perform selection based on a current interaction requirement, the first information, and the second information, thereby the setting of the current interaction mode is achieved.

In some embodiments, the data transmission method further includes:
determining a current interaction mode, wherein the current interaction mode includes a secure mode and a non-secure mode;
the process of enabling the server to respond to the first user request and return corresponding data to the client includes:
in response to the current interaction mode being the non-secure interaction mode, enabling the server to respond to the first user request and return the corresponding data to the client; and
the data transmission method further includes:
in response to the current interaction mode being the secure interaction mode, enabling the server not to respond to the first user request.

In the present embodiment, in a case that the current interaction mode is the secure interaction mode, in response to the presence of the first user request initiated based on the non-security protocol on the client, the client may output the first user request to the server, but the server does not respond to the first user request directly transmitted from the client, thereby the data transmission security is improved.

In some embodiments, in response to the current interaction mode being the secure interaction mode, while transmitting the first user request to the server, the data transmission method further includes:
generating a prompting message corresponding to re-initiating a user request.

Considering that the server does not respond to the first user request directly transmitted from the client, the prompting message corresponding to re-initiating the user request is generated to facilitate the user to re-initiate the user request.

In some embodiments, the data transmission method further includes:
prompting first information and second information, wherein the first information corresponds to the secure mode, and the second information corresponds to the non-secure mode;
the process of determining a current interaction mode includes:
determining that the current interaction mode is the secure mode in response to receiving a first selection instruction transmitted by the user based on the first information; and
determining that the current interaction mode is the non-secure mode in response to receiving a second selection instruction transmitted by the user based on the second information.

In some embodiments, the process of enabling the server not to respond to the first user request in response to the current interaction mode being the secure interaction mode includes:
in response to the current interaction mode being the secure interaction mode, determining, by the server, all target ports configured to receive the first user request, and responding, by the server, to none of the first user requests from any one of the target ports.

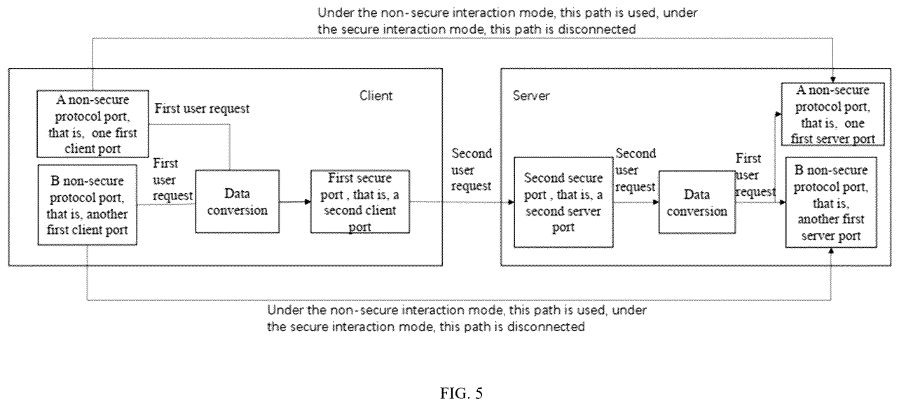

It may be seen from FIG. 5 that the client includes a first client port and a second client port, the server includes a first client port and a second client port, wherein the first client port of the client is correspondingly connected to the first server port of the server and is configured to transmit the first user request, and the second client port of the client is correspondingly connected to the second server port of the server and configured to transmit the second user request; and in response to the current interaction mode being the secure interaction mode, the server responds to none of the user requests received by any first server port, and only responds to the user request received by the second server port, wherein the first server port is the target port.

In some embodiments, the data transmission method further includes:
establishing a conversion relationship between each non-security protocol and each security protocol according to a user setting instruction; and
the process of determining the target security protocol includes:
determining the target security protocol according to the non-security protocol corresponding to the first user request and the conversion relationship.

In the present embodiment, the user may pre-establish the conversion relationship between each non-security protocol and each security protocol; for example, assuming that the non-security protocol includes A1, A2, and A3, and the security protocol includes B1, B2, and B3, the conversion relationship is as follows: A1→B1, A2→B2, A3→B3; and therefore, when the non-security protocol corresponding to the first user request is A1, the target security protocol is B1, and the request information in A1 is regrouped according to the constraint format of B1.

In some embodiments, the request information includes a protocol type and a protocol data packet;
the process of enabling the server to respond to the second user request and return the corresponding data to the client includes:
parsing, by the server, the protocol type and the protocol data packet in the second user request to obtain data corresponding to the protocol type and the protocol data packet; and
forming the data into a return data packet according to the constraint format corresponding to the target security protocol, and transmitting the return data packet to the client.

After receiving the second user request initiated by the client based on the target security protocol, the server parses the second user request first, determines the non-security protocol according to a protocol type field, and obtains a protocol data field; subsequently, the server forms a corresponding non-security protocol instruction according to the non-security protocol, and transmits the non-security protocol instruction to a corresponding service response end within the server; and the service response end normally processes the acquired non-security protocol instruction, forms the acquired data according to the constraint format corresponding to the target security protocol into the return data packet, and transmits the return data packet to the client.

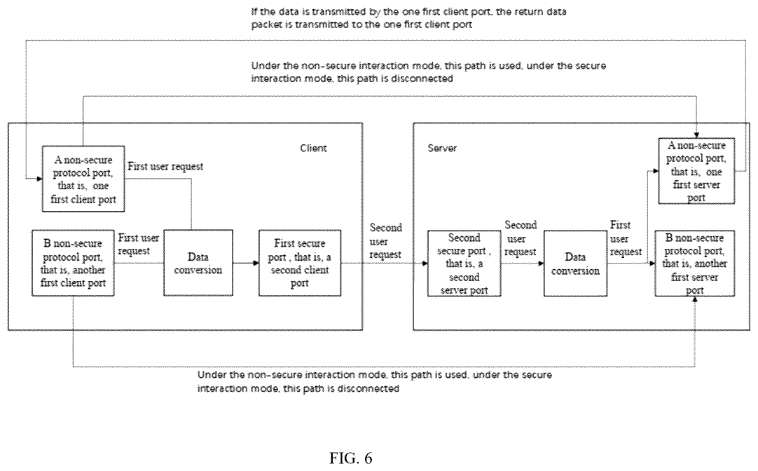

It may be seen from FIG. 6 that when the server receives the user request through the first server port, the server may transmit the return data packet to the client through the first server port; and when the server receives the user request through the second server port, the server may transmit the return data packet to the client through the second server port.

In some embodiments, the data transmission method further includes:
parsing the return data packet, and forming data in the return data packet according to the constraint format of the target security protocol into a non-security protocol data packet.

In some embodiments, the process of parsing the return data packet includes:
parsing a protocol type in the return data packet; and
the data transmission method further includes:
determining the target security protocol according to the protocol type in the return data packet.

After receiving the return data packet, the client reversely unpacks the return data packet into non-security protocol-related data.

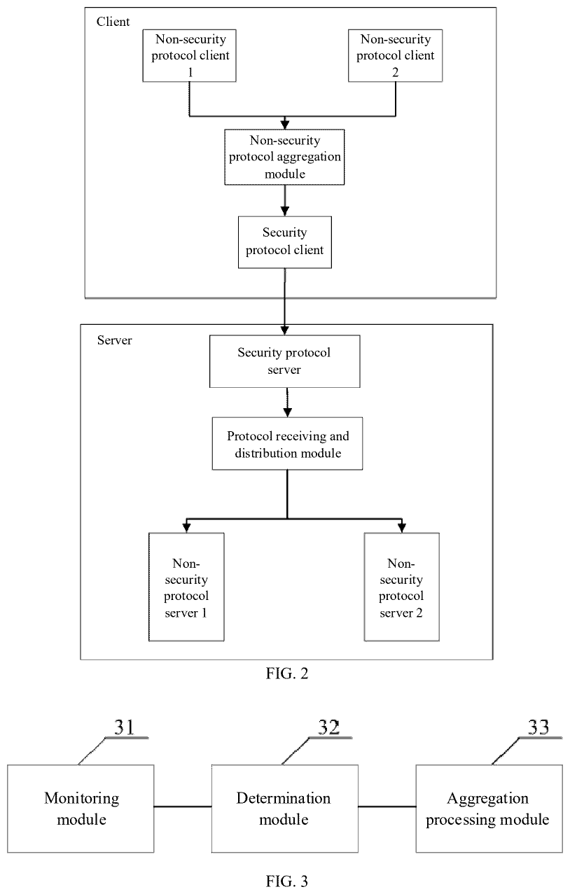

In conclusion, as shown in FIG. 2, the client includes a plurality of non-security protocol clients, a non-security protocol aggregation module, and a security protocol client; the non-security protocol aggregation module is responsible for aggregating original non-security protocol requests of the user for analysis, and generating security protocol data packets, wherein there are a plurality of methods that may achieve the aggregation of the non-security protocols: first, original non-security protocol executable programs are replaced, the user transmits the request through a negotiated instruction, and to be imperceptible to a user-side management system, in the instruction, an executable program (hereinafter referred to as a non-security alternative program) with the same name as the non-security protocol, such as SNMP needs to be developed; the executable program may replace an original executable program in the client system; when the user initiates the request through the non-security alternative program, the non-security alternative program transmits the instruction to the non-security protocol aggregation module for analysis; and second, without replacing the original non-security protocol executable program, the non-security protocol aggregation module monitors the appointed multiple non-security protocol ports, acquires data, and then analyzes the data. The non-security protocol aggregation module analyzes the non-security protocol request transmitted from the client, identifies appointed key information, such as an IP address of the target server, a port, a protocol type, and a protocol data packet, and transmits an analysis result to a secure client. The non-security protocol aggregation module is also responsible for the protocol analysis on the returned data; the security protocol client may receive the protocol appointed data packet; the non-security protocol aggregation module may reversely unpack the non-security protocol-related data as described above, and aggregates the data into a non-security protocol data packet, and returns the same to the non-security protocol client. The security protocol client packs the aforementioned data according to an appointed protocol format into the security protocol data such as “protocol type: X, port: Y, and protocol data: a, b, c, and d”, and transmits the packed secure data packet to the security protocol client according to the IP address.

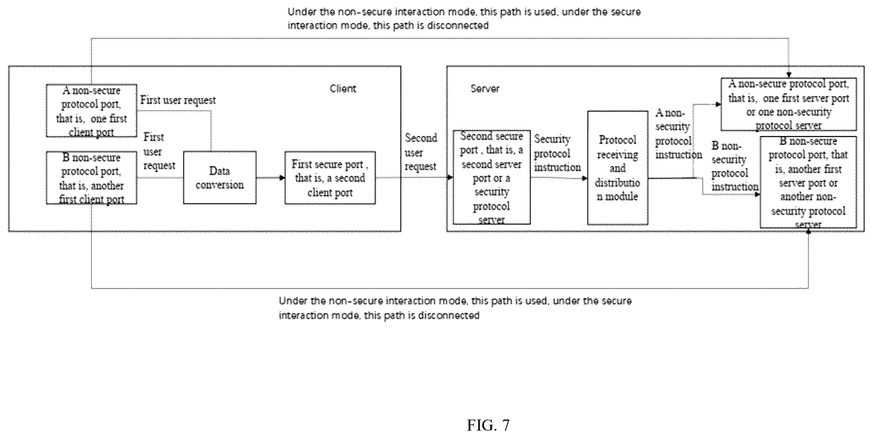

Referring to FIG. 7, the server includes a security protocol server, a protocol receiving and distribution module, and a plurality of non-security protocol servers; the security protocol server may receive a predetermined security protocol instruction, transmits the predetermined security protocol instruction to the protocol receiving and distribution module for processing, and the protocol receiving and distribution module identifies the non-security protocol type according to a protocol type field in instruction data, and acquires a protocol data field. The protocol receiving and distribution module may form the non-security protocol instruction, and transmit the non-security protocol instruction to the corresponding non-security protocol server. The corresponding non-security protocol server normally processes the received instruction, and returns a return result to the protocol receiving and distribution module. The protocol receiving and distribution module forwards the data to the non-security protocol server, and the non-security protocol server returns the data to the client. It may be understood that the non-security protocol and the security protocol of the server are unchanged on the basis of the original solution, and only the protocol receiving and distribution module needs to be added to the security protocol server.

In a second aspect, referring to FIG. 3, FIG. 3 is a schematic structural diagram of a data transmission system provided by the present application. The data transmission system includes:
a monitoring module 31, configured to parse request information in a first user request, in response to acquiring the first user request initiated based on any one of the non-security protocols;
a determination module 32, configured to determine a target security protocol; and
an aggregation processing module 33, configured to form the request information into a second user request according to a constraint format corresponding to the target security protocol, and transmit the second user request to a server, enabling the server to respond to the second user request and return corresponding data to a client.

In some embodiments, the monitoring module is further configured to
determine a transmission port corresponding to each non-security protocol; and
monitor each transmission port to intercept the first user request outputted through the transmission port.

In some embodiments, the data transmission system further includes:
a data transmission module, configured to transmit the first user request to the server, in response to acquiring the first user request initiated based on any one of the non-security protocols, enabling the server to respond to the first user request and return the corresponding data to the client.

In some embodiments, the process of forming request information into the second user request according to the constraint format corresponding to the target security protocol includes:
determining the constraint format corresponding to the target security protocol; and
adding the request information into a field corresponding to the target security protocol according to the constraint format to obtain the second user request.

In some embodiments, the request information includes a protocol type;
the process of transmitting the second user request to the server includes:
transmitting the second user request to a second secure port, corresponding to the protocol type, of the server through a first secure port corresponding to the protocol type; and
the process of enabling the server to respond to the second user request and return the corresponding data to the client includes:
after the server receives the second user request through the second secure port, forwarding the second user request to a non-secure port corresponding to the second secure port for processing, and returning the corresponding data to the client.

In some embodiments, the data transmission system further includes:
a mode determination module, configured to determine a current interaction mode, wherein the current interaction mode includes a secure mode and a non-secure mode;
the process of transmitting the first user request to the server in response to acquiring the first user request initiated based on any one of the non-security protocols includes:
determining that the current interaction mode is the non-secure interaction mode, transmitting the first user request to the server, in response to acquiring the first user request initiated based on any one of the non-security protocols; and
the data transmission system further includes:
a first control module, configured to reject transmitting the first user request to the server in response to acquiring the first user request initiated based on any one of the non-security protocols, determining that the current interaction mode is the secure interaction mode.

In some embodiments, the data transmission system further includes:
a first prompting module, configured to generate a prompting message corresponding to re-initiating a user request.

In some embodiments, the data transmission system further includes:
a second prompting module, configured to prompt first information and second information, wherein the first information corresponds to the secure mode, and the second information corresponds to the non-secure mode;
the process of determining the current interaction mode includes:
determining that the current interaction mode is the secure mode in response to receiving a first selection instruction transmitted by the user based on the first information; and
determining that the current interaction mode is the non-secure mode in response to receiving a second selection instruction transmitted by the user based on the second information.

In some embodiments, the data transmission system further includes:
a mode determination module, configured to determine a current interaction mode, wherein the current interaction mode includes a secure mode and a non-secure mode;
the process of enabling the server to respond to the first user request and return the corresponding data to the client includes:
in response to the current interaction mode being the non-secure interaction mode, enabling the server to respond to the first user request and return the corresponding data to the client; and
the data transmission system further includes:
a second control module, configured to control the server not to respond to the first user request in response to the current interaction mode being the secure interaction mode.

In some embodiments, the data transmission system further includes:
a third prompting module, configured to generate prompt information corresponding to re-initiating a user request.

In some embodiments, the data transmission system further includes:
a fourth prompting module, configured to prompt first information and second information, wherein the first information corresponds to the secure mode, and the second information corresponds to the non-secure mode;
the process of determining the current interaction mode includes:
determining that the current interaction mode is the secure mode in response to receiving a first selection instruction transmitted by the user based on the first information; and
determining that the current interaction mode is the non-secure mode in response to receiving a second selection instruction transmitted by the user based on the second information.

In some embodiments, the process of enabling the server not to respond to the first user request in response to the current interaction mode being the secure interaction mode includes:
in response to the current interaction mode being the secure interaction mode, determining, by the server, all target ports configured to receive the first user request, and responding, by the server, to none of the first user request received by any one of the target ports.

In some embodiments, the process of determining the target security protocol includes:
determining the target security protocol based on a user selection instruction.

In some embodiments, the process of determining the target security protocol includes:
acquiring a non-security protocol corresponding to the first user request; and
determining the target security protocol corresponding to the non-security protocol.

In some embodiments, the data transmission system further includes:
a pre-establishing module, configured to establish a conversion relationship between each non-security protocol and each security protocol according to a user setting instruction;
the process of determining the target security protocol includes:
determining the target security protocol according to the non-security protocol corresponding to the first user request and the conversion relationship.

In some embodiments, the request information includes an IP address of the target server; and
the process of transmitting the second user request to the server includes:
transmitting the second user request to the target server according to the IP address.

In some embodiments, the non-security protocol includes one or more of the intelligent platform management interface protocol, the simple network management protocol, and the electronic mail protocol.

In some embodiments, the request information includes a protocol type and a protocol data packet;
the process of enabling the server to respond to the second user request and return the corresponding data to the client includes:
parsing, by the server, the protocol type and the protocol data packet in the second user request to obtain data corresponding to the protocol type and the protocol data packet; and
forming the data into a return data packet according to the constraint format corresponding to the target security protocol, and transmitting the return data packet to the client.

In some embodiments, the aggregation processing module 33 is further configured to parse the return data packet, and form the data in the return data packet into a non-security protocol data packet according to the constraint format of the target security protocol.

In some embodiments, the process of parsing the return data packet includes:
parsing a protocol type in the return data packet; and
the aggregation processing module 33 is further configured to determine the target security protocol according to the protocol type in the return data packet.

In a third aspect, an electronic device is further provided by the present application, which includes:
a memory, configured to store computer programs; and
a processor, configured to implement the steps of the data transmission method as described in any one of the above embodiments, in response to executing the computer programs,
wherein the memory includes a non-transitory readable storage medium and an internal memory. The non-transitory readable storage medium has an operating system and computer-readable instructions stored therein, and the internal memory provides an environment for running the operating system and the computer-readable instructions in the non-transitory readable storage medium. The processor, when executing the computer programs stored in the memory, may implement the following steps: parsing request information in a first user request, in response to acquiring the first user request initiated based on any one of the non-security protocols; determining a target security protocol; and forming the request information into a second user request according to a constraint format corresponding to the target security protocol, and transmitting the second user request to a server, enabling the server to respond to the second user request and return corresponding data to the client.

As may be seen in the present embodiment, after the first user request initiated by the user through any one of the non-security protocols is acquired, the request information in the first user request is regrouped into the second user request according to the constraint format of the determined target security protocol, and then the second user request is transmitted from the client, conversion of multiple non-security protocols is supported, and the second user request based on the target security protocol is less susceptible to be stolen during the transmission, thereby the security and the reliability of the data transmission are improved.

In some embodiments, the processor, when executing computer sub-programs stored in the memory, may implement the following steps: determining a constraint format corresponding to the target security protocol; and adding the request information into a field corresponding to the target security protocol according to the constraint format to obtain the second user request.

In some embodiments, the request information includes a protocol type; and the processor, when executing computer sub-programs stored in the memory, may implement the following steps: transmitting the second user request to a second secure port, corresponding to the protocol type, of the server through a first secure port corresponding to the protocol type; and after the server receives the second user request through the second secure port, forwarding the second user request to a non-secure port corresponding to the second secure port for processing, and returning the corresponding data to the client.

In some embodiments, the processor, when executing computer sub-programs stored in the memory, may implement the following steps: determining a transmission port corresponding to each non-security protocol; and monitoring each transmission port to intercept the first user request outputted through the transmission port.

In some embodiments, the processor, when executing computer sub-programs stored in the memory, may implement the following steps: transmitting the first user request to the server, in response to acquiring the first user request initiated based on any one of the non-security protocols, enabling the server to respond to the first user request and return the corresponding data to the client.

In some embodiments, the processor, when executing computer sub-programs stored in the memory, may implement the following steps: determining a current interaction mode, wherein the current interaction mode includes a secure mode and a non-secure mode; when the current interaction mode is the non-secure interaction mode, transmitting the first user request to the server, in response to acquiring the first user request initiated based on any one of the non-security protocols; and when the current interaction mode is the secure interaction mode, rejecting transmitting the first user request to the server, in response to acquiring the first user request initiated based on any one of the non-security protocols.

In some embodiments, the processor, when executing computer sub-programs stored in the memory, may implement the following steps: when the current interaction mode is the secure interaction mode, in response to acquiring the first user request initiated based on any one of the non-security protocols, rejecting transmitting the first user request to the server, and simultaneously generating a prompting message corresponding to re-initiating a user request.

In some embodiments, the processor, when executing computer sub-programs stored in the memory, may implement the following steps: prompting first information and second information, wherein the first information corresponds to a secure mode, and the second information corresponds to a non-secure mode; determining that the current interaction mode is the secure mode in response to receiving a first selection instruction transmitted by the user based on the first information; and determining that the current interaction mode is the non-secure mode in response to receiving a second selection instruction transmitted by the user based on the second information.

In some embodiments, the processor, when executing computer sub-programs stored in the memory, may implement the following steps: determining a current interaction mode, wherein the current interaction mode includes a secure mode and a non-secure mode; enabling the server to respond to the first user request and return the corresponding data to the client in response to the current interaction mode being the non-secure interaction mode; and enabling the server not to respond to the first user request in response to the current interaction mode being the secure interaction mode.

In some embodiments, the processor, when executing computer sub-programs stored in the memory, may implement the following step: in response to the current interaction mode being the secure interaction mode, transmitting the first user request to the server, and simultaneously generating a prompting message corresponding to re-initiating a user request.

In some embodiments, the processor, when executing computer sub-programs stored in the memory, may implement the following steps: prompting first information and second information, wherein the first information corresponds to the secure mode, and the second information corresponds to the non-secure mode; determining that the current interaction mode is the secure mode, in response to receiving a first selection instruction transmitted by the user based on the first information; and determining that the current interaction mode is the non-secure mode, in response to receiving a second selection instruction transmitted by the user based on the second information.

In some embodiments, the processor, when executing computer sub-programs stored in the memory, may implement the following steps: in response to the current interaction mode being the secure interaction mode, determining, by the server, all target ports configured to receive the first user request, and responding, by the server, to none of the first user request received by any one of the target ports.

In some embodiments, the processor, when executing computer sub-programs stored in the memory, may implement the following step: determining a target security protocol based on the user selection instruction.

In some embodiments, the processor, when executing computer sub-programs stored in the memory, may implement the following steps: acquiring the non-security protocol corresponding to the first user request; and determining the target security protocol corresponding to the non-security protocol.

In some embodiments, the processor, when executing computer sub-programs stored in the memory, may implement the following steps: establishing a conversion relationship between each non-security protocol and each security protocol according to a user setting instruction; and determining the target security protocol according to the non-security protocol corresponding to the first user request and the conversion relationship.

In some embodiments, the processor, when executing computer sub-programs stored in the memory, may implement the following steps: transmitting the second user request to the target server according to an IP address.

In some embodiments, the processor, when executing computer sub-programs stored in the memory, may implement the following steps: the request information includes a protocol type and a protocol data packet; parsing, by the server, the protocol type and the protocol data packet in the second user request to obtain data corresponding to the protocol type and the protocol data packet; and forming the data into a return data packet according to the constraint format corresponding to the target security protocol, and transmitting the return data packet to the client.

In some embodiments, the processor, when executing computer sub-programs stored in the memory, may implement the following steps: parsing the return data packet, and forming the data in the return data packet into a non-security protocol data packet according to the constraint format of the target security protocol.

In some embodiments, the processor, when executing computer sub-programs stored in the memory, may implement the following steps: parsing the protocol type in the return data packet; and determining the target security protocol according to the protocol type in the return data packet.

On the basis of the above embodiments, the electronic device further includes:
an input interface, connected to the processor, and configured to acquire external computer programs, parameters, and instructions, and controlled by the processor to store them into the memory, wherein the input interface may be connected to an input apparatus and receive parameters or instructions manually inputted by the user. The input apparatus may be a touch layer overlaid on a display screen, or may be a key, a trackball or a touchpad disposed on a terminal housing;
a display unit, connected to the processor, and configured to display data transmitted from the processor, wherein the display unit may be a liquid crystal display screen or an electronic-ink display screen; and
a network port, connected to the processor, and configured to be in communication connection with various external terminal devices, wherein the communication connection may employ a wired communication technology or a wireless communication technology, such as mobile high-definition link (MHL), universal serial bus (USB), high-definition multimedia interface (HDMI), wireless fidelity (WiFi), a Bluetooth communication technology, a low-power-consumption Bluetooth communication technology, and IEEE802.11s-based communication technology.

In a fourth aspect, a non-transitory readable storage medium is further provided by the present application, wherein the non-transitory readable storage medium has computer programs stored thereon, and the computer programs, when executed by a processor, implement the steps of the data transmission method as described in any one of the above embodiments.

The non-transitory readable storage medium may include media that may store program codes, such as a universal serial bus (USB) flash drive, a portable hard disk, a read-only memory (ROM), a random access memory (RAM), a magnetic disk or a compact disk. The non-transitory readable storage medium has the computer programs stored thereon, and the computer programs, when executed by the processor, implement the following steps: parsing request information in a first user request, in response to acquiring the first user request initiated based on any one of the non-security protocols; determining a target security protocol; and forming the request information into a second user request according to a constraint format corresponding to the target security protocol, and transmitting the second user request to a server, enabling the server to respond to the second user request and return corresponding data to a client.

As may be seen in the present embodiment, after the first user request initiated by the user through any one of the non-security protocols is acquired, the request information in the first user request is regrouped into the second user request according to the constraint format of the determined target security protocol, and then the second user request is transmitted from the client, conversion of multiple non-security protocols is supported, and the second user request based on the target security protocol is less susceptible to be stolen during the transmission, thereby the security and the reliability of the data transmission are improved.

In some embodiments, the processor, when executing computer sub-programs stored in the memory, may implement the following steps: determining the constraint format corresponding to the target security protocol; and adding the request information into a field corresponding to the target security protocol according to the constraint format to obtain the second user request.

In some embodiments, the request information includes a protocol type; and the processor, when executing computer sub-programs stored in the memory, may implement the following steps: transmitting the second user request to a second secure port, corresponding to the protocol type, of the server through the first secure port corresponding to the protocol type; and after the server receives the second user request through the second secure port, forwarding the second user request to a non-secure port corresponding to the second secure port for processing, and returning the corresponding data to the client.

In some embodiments, the processor, when executing computer sub-programs stored in the memory, may implement the following steps: determining a transmission port corresponding to each non-security protocol; and monitoring each transmission port to intercept the first user request outputted through the transmission port.

In some embodiments, the processor, when executing computer sub-programs stored in the memory, may implement the following steps: transmitting the first user request to the server, in response to acquiring the first user request initiated based on any one of the non-security protocols, enabling the server to respond to the first user request and return the corresponding data to the client.

In some embodiments, the processor, when executing computer sub-programs stored in the memory, may implement the following steps: determining a current interaction mode, wherein the current interaction mode includes a secure mode and a non-secure mode; when the current interaction mode is the non-secure interaction mode, transmitting the first user request to the server, in response to acquiring the first user request initiated based on any one of the non-security protocols; and when the current interaction mode is the secure interaction mode, rejecting transmitting the first user request to the server, in response to acquiring the first user request initiated based on any one of the non-security protocols.

In some embodiments, the processor, when executing computer sub-programs stored in the memory, may implement the following steps: when the current interaction mode is the secure interaction mode, in response to acquiring the first user request initiated based on any one of the non-security protocols, rejecting transmitting the first user request to the server, and generating a prompting message corresponding to re-initiating a user request.

In some embodiments, the processor, when executing computer sub-programs stored in the memory, may implement the following steps: prompting first information and second information, wherein the first information corresponds to a secure mode, and the second information corresponds to a non-secure mode; determining that the current interaction mode is the secure mode in response to a first selection instruction transmitted by the user based on the first information being received; and determining that the current interaction mode is the non-secure mode in response to a second selection instruction transmitted by the user based on the second information being received.

In some embodiments, the processor, when executing computer sub-programs stored in the memory, may implement the following steps: determining a current interaction mode, wherein the current interaction mode includes a secure mode and a non-secure mode; enabling the server to respond to the first user request and return the corresponding data to the client in response to the current interaction mode being the non-secure interaction mode; and enabling the server not to respond to the first user request in response to the current interaction mode being the secure interaction mode.

In some embodiments, the processor, when executing computer sub-programs stored in the memory, may implement the following step: in response to the current interaction mode being the secure interaction mode, transmitting the first user request to the server, and simultaneously generating a prompting message corresponding to re-initiating a user request.

In some embodiments, the processor, when executing computer sub-programs stored in the memory, may implement the following steps: prompting first information and second information, wherein the first information corresponds to the secure mode, and the second information corresponds to the non-secure mode; determining that the current interaction mode is the secure mode, in response to receiving a first selection instruction transmitted by the user based on the first information; and determining that the current interaction mode is the non-secure mode, in response to receiving a second selection instruction transmitted by the user based on the second information.

In some embodiments, the processor, when executing computer sub-programs stored in the memory, may implement the following steps: in response to the current interaction mode being the secure interaction mode, determining, by the server, all target ports configured to receive the first user request, and responding, by the server, to none of the first user request received by any one of the target ports.

In some embodiments, the processor, when executing computer sub-programs stored in the memory, may implement the following step: determining a target security protocol based on the user selection instruction.

In some embodiments, the processor, when executing computer sub-programs stored in the memory, may implement the following steps: acquiring the non-security protocol corresponding to the first user request; and determining the target security protocol corresponding to the non-security protocol.

In some embodiments, the processor, when executing computer sub-programs stored in the memory, may implement the following steps: establishing a conversion relationship between each non-security protocol and each security protocol according to a user setting instruction; and determining the target security protocol according to the non-security protocol corresponding to the first user request and the conversion relationship.

In some embodiments, the processor, when executing computer sub-programs stored in the memory, may implement the following steps: transmitting the second user request to the target server according to an IP address.

In some embodiments, the processor, when executing computer sub-programs stored in the memory, may implement the following steps: the request information includes a protocol type and a protocol data packet; parsing, by the server, the protocol type and the protocol data packet in the second user request to obtain data corresponding to the protocol type and the protocol data packet; and forming the data into a return data packet according to the constraint format corresponding to the target security protocol, and transmitting the return data packet to the client.

In some embodiments, the processor, when executing computer sub-programs stored in the memory, may implement the following steps: parsing the return data packet, and forming the data in the return data packet into a non-security protocol data packet according to the constraint format of the target security protocol.

In some embodiments, the processor, when executing computer sub-programs stored in the memory, may implement the following steps: parsing the protocol type in the return data packet; and determining the target security protocol according to the protocol type in the return data packet.

In a fifth aspect, a data interaction system is further provided by the present application, which includes a server and a client, wherein the client includes the electronic device as described in the foregoing embodiments. The data interaction system may be a server system or a storage system, or a combination thereof.

The description of the data interaction system provided by the present application may be referred to the aforementioned embodiments, and details are not repeated herein.

The data interaction system provided by the present application has the same beneficial effects as the data transmission method.

It also should be noted that relational terms used herein such as first and second, etc. are only used herein to distinguish one entity or operation from another entity or operation, and do not necessarily require or imply any such actual relation or sequence between these entities or operations. Moreover, terms “include”, “contain” or any other variations thereof are intended to cover a non-exclusive inclusion, so that a process, method, article, or apparatus including a series of elements does not include only those elements but also other elements not expressly listed or also includes the intrinsic elements of the process, method, article, or apparatus. Without further limitations, an element defined by the sentence “including an . . . ” do not exclude the presence of other same elements in the process, method, article or apparatus including the element.

The above description of the disclosed embodiments enables those skilled in the art to implement or use the present application. Various modifications to these embodiments are apparent for those skilled in the art. The general principles defined herein may be implemented in other embodiments without departing from the spirit or scope of the present application. Therefore, the present application may not be limited to these embodiments described herein, but shall conform to the widest scope consistent with the principles and novel characteristics disclosed herein.

1. A data transmission method, applied to a client, and comprising:
parsing request information in a first user request, in response to acquiring the first user request initiated based on any one of non-security protocols;
determining a target security protocol, wherein a security of the target security protocol is larger than a security of each of the non-security protocols; and
forming the request information into a second user request according to a constraint format corresponding to the target security protocol, and transmitting the second user request to a server, enabling the server to respond to the second user request and return corresponding data to the client.

2. The data transmission method according to claim 1, wherein the forming the request information into the second user request according to the constraint format corresponding to the target security protocol comprises:
determining the constraint format corresponding to the target security protocol; and
adding the request information into a field corresponding to the target security protocol according to the constraint format to obtain the second user request.

3. The data transmission method according to claim 1, wherein the request information comprises a protocol type;
the transmitting the second user request to the server comprises:
transmitting the second user request to a second secure port, corresponding to the protocol type, of the server through a first secure port corresponding to the protocol type; and
the enabling the server to respond to the second user request and return the corresponding data to the client comprises:
after the server receives the second user request through the second secure port, forwarding the second user request to a non-secure port corresponding to the second secure port for processing, and returning the corresponding data to the client.

4. The data transmission method according to claim 1, wherein before the acquiring the first user request initiated based on any one of the non-security protocols, the data transmission method further comprises:
determining a transmission port corresponding to each non-security protocol; and
monitoring each transmission port to intercept the first user request outputted through the transmission port.

5. The data transmission method according to claim 1, wherein the data transmission method further comprises:
transmitting the first user request to the server in response to acquiring the first user request initiated based on any one of the non-security protocols, enabling the server to respond to the first user request and return the corresponding data to the client.

6. The data transmission method according to claim 5, wherein the data transmission method further comprises:
determining a current interaction mode, wherein the current interaction mode comprises a secure mode and a non-secure mode;
the transmitting the first user request to the server in response to acquiring the first user request initiated based on any one of the non-security protocols comprises:
determining that the current interaction mode is the non-secure interaction mode, transmitting the first user request to the server in response to acquiring the first user request initiated based on any one of the non-security protocols; and
the data transmission method further comprises:
determining that the current interaction mode is the secure interaction mode, rejecting transmitting the first user request to the server in response to acquiring the first user request initiated based on any one of the non-security protocols.

7. The data transmission method according to claim 6, wherein the data transmission method further comprises:
prompting first information and second information, wherein the first information corresponds to the secure mode, and the second information corresponds to the non-secure mode; and
the determining the current interaction mode comprises:
determining that the current interaction mode is the secure mode in response to receiving a first selection instruction transmitted by a user based on the first information, and determining that the current interaction mode is the non-secure mode in response to receiving a second selection instruction transmitted by the user based on the second information.

8. The data transmission method according to claim 5, wherein the data transmission method further comprises:
determining a current interaction mode, wherein the current interaction mode comprises a secure mode and a non-secure mode;
the enabling the server to respond to the first user request and return the corresponding data to the client comprises:
in response to the current interaction mode being the non-secure interaction mode, enabling the server to respond to the first user request and return the corresponding data to the client; and
the data transmission method further comprises:
in response to the current interaction mode being the secure interaction mode, enabling the server not to respond to the first user request.

9. The data transmission method according to claim 8, wherein the data transmission method further comprises:
prompting first information and second information, wherein the first information corresponds to the secure mode, and the second information corresponds to the non-secure mode; and
the determining the current interaction mode comprises:
determining that the current interaction mode is the secure mode in response to receiving a first selection instruction transmitted by a user based on the first information, and determining that the current interaction mode is the non-secure mode in response to receiving a second selection instruction transmitted by the user based on the second information.

10. The data transmission method according to claim 8, wherein the enabling the server not to respond to the first user request in response to the current interaction mode being the secure interaction mode comprises:
in response to the current interaction mode being the secure interaction mode, determining, by the server, all target ports configured to receive the first user request, and responding, by the server, to none of the first user request received by any one of the target ports.

11. The data transmission method according to claim 1, wherein the determining the target security protocol comprises:
determining the target security protocol based on a user selection instruction.

12. The data transmission method according to claim 1, wherein the determining the target security protocol comprises:
acquiring a non-security protocol corresponding to the first user request; and
determining the target security protocol corresponding to the non-security protocol.

13. The data transmission method according to claim 12, wherein the data transmission method further comprises:
establishing a conversion relationship between each non-security protocol and each security protocol according to a user setting instruction; and
the determining the target security protocol comprises:
determining the target security protocol according to the non-security protocol corresponding to the first user request and the conversion relationship.

14. The data transmission method according to claim 1, wherein the request information comprises an Internet protocol (IP) address of a target server; and
the transmitting the second user request to the server comprises:
transmitting the second user request to the target server according to the IP address.

15. The data transmission method according to claim 1, wherein the non-security protocol comprises one or more of an intelligent platform management interface protocol, a simple network management protocol, and an electronic mail protocol.

16. The data transmission method according to claim 1, wherein the request information comprises a protocol type and a protocol data packet;
the enabling the server to respond to the second user request and return the corresponding data to the client comprises:
parsing, by the server, the protocol type and the protocol data packet in the second user request to obtain data corresponding to the protocol type and the protocol data packet; and
forming the data into a return data packet according to the constraint format corresponding to the target security protocol, and transmitting the return data packet to the client.

17. The data transmission method according to claim 16, wherein the data transmission method further comprises:
parsing the return data packet, and forming the data in the return data packet into a non-security protocol data packet according to the constraint format of the target non-security protocol.

18. An electronic device, comprising:
a memory, configured to store computer programs; and
a processor, configured to implement the steps of the data transmission method according to claim 1 in response to executing the computer programs.

19. A data interaction system, comprising the server and the client, wherein the client comprises the electronic device according to claim 18.

20. A non-transitory readable storage medium, having computer programs stored thereon, wherein the computer programs, in response to being executed by a processor, implement the steps of the data transmission method according to claim 1.
